(19) United States
(12) Patent Application Publication
(10) Pub. No.: US 2026/0020718 A1
(43) Pub. Date: Jan. 22, 2026

(54) Utensil Protection Device

(71) Applicant: Caroline Hofer, Chesapeake Beach, MD (US)

(72) Inventor: Caroline Hofer, Chesapeake Beach, MD (US)

(21) Appl. No.: 19/209,064

(22) Filed: May 15, 2025

Related U.S. Application Data
(60) Provisional application No. 63/672,804, filed on Jul. 18, 2024.

(51) Int. Cl. A47J 37/07; A47J 47/16; B65D 43/16; B65D 43/22; B65D 51/16

(52) U.S. Cl. CPC A47J 37/0786; A47J 47/16; B65D 43/164; B65D 43/22; B65D 51/1611

(57) ABSTRACT

A utensil protection device is provided. The device is comprised of a body with two hinged halves made of durable, heat and UV-resistant materials such as metal or silicone. These halves may be secured with locking mechanisms, forming a protective, airtight seal, enhanced by optional gaskets. The interior of the device includes fasteners to hold either the entire utensil or just its head, with adjustable grooves or elastic bands for securing utensils of various sizes. The device may also feature ventilation openings to prevent moisture buildup and external fasteners for mounting to surfaces like grills or countertops. Additionally, a method for storing and protecting utensils using this device is provided, detailing the steps for securing the utensils and mounting the device.

### CROSS-REFERENCE TO RELATED APPLICATION

The present application claims priority to, and the benefit of, U.S. Provisional Application No. 63/672,804, which was filed on Jul. 18, 2024, and is incorporated herein by reference in its entirety.

### FIELD OF THE INVENTION

The present invention relates generally to the field of utensil storage devices. More specifically, the present invention relates to a utensil protection device that protects the head and/or entire portion of a cooking utensil from contamination while cooking outdoors. Accordingly, the present disclosure makes specific reference thereto. Nonetheless, it is to be appreciated that aspects of the present invention are also equally applicable to other like applications, devices, and methods of manufacture.

### BACKGROUND

When grilling outdoors, it is a frequent challenge for grillers to maintain the cleanliness of their utensils. Outdoor environments expose grilling tools to various contaminants, including flies that land on surfaces, airborne debris like pollen, dust, and even dirt that can come into contact with utensils when they are laid down on or near the grill. The open-air setting and fluctuating weather conditions make it difficult to keep utensils free from germs and other harmful particles. This contamination poses a risk to food safety, as grill owners struggle to ensure that their utensils remain sanitary and safe for use throughout the cooking process. Maintaining proper hygiene can be particularly challenging when handling raw meats or transferring food from the grill to the serving area, increasing the likelihood of cross-contamination and potential health hazards.

Therefore, there exists a long-felt need in the art for a device that allows a user to maintain the cleanliness of their cooking utensils. There also exists a long-felt need in the art for a utensil protection device. More specifically, there exists a long-felt need in the art for a utensil protection device that protects cooking utensils from contaminants. Further, there exists a long-felt need in the art for a utensil protection device that protects cooking utensils from contaminants by enclosing a portion or the entirety of the utensil.

The subject matter disclosed and claimed herein, in one embodiment thereof, comprises a utensil protection device. The device is comprised of a body with two hinged halves made of durable, heat and UV-resistant materials such as metal or silicone. These halves may be secured with locking mechanisms, forming a protective, airtight seal, enhanced by optional gaskets. The interior of the device includes fasteners to hold either the entire utensil or just its head, with adjustable grooves or elastic bands for securing utensils of various sizes. The device may also feature ventilation openings to prevent moisture buildup and external fasteners for mounting to surfaces like grills or countertops. Additionally, a method for storing and protecting utensils using this device is provided, detailing the steps for securing the utensils and mounting the device.

In this manner, the utensil protection device of the present invention accomplishes all the forgoing objectives and provides a device that allows a user to maintain the cleanliness of their cooking utensils. More specifically, the device protects cooking utensils from contaminants. The device does so by enclosing a portion or the entirety of the utensil.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a utensil protection device. The device is comprised of a body with a first half and a second half connected by at least one hinge. The halves may take various geometric shapes and are made from durable, food-grade materials such as metal or silicone, resistant to heat and UV radiation. The halves can be secured together by a locking mechanism, which may include latches, clasps, magnetic seals, or screw-type closures. Additional seals or gaskets may be incorporated to enhance airtight and watertight properties, protecting stored utensils from contaminants.

Each half features interior surfaces with fasteners configured to secure the head or the entire utensil within the device. In cases where only the utensil head is stored, openings in each half allow the handle to protrude, with sealing components ensuring protection. The interior surfaces may be lined with soft materials, and the fasteners may include adjustable grooves, channels, clastic bands, or clips to hold utensils securely in place. Cushioning elements may be added for additional protection.

The body may also feature ventilation openings to promote airflow and prevent moisture buildup, reducing the risk of bacterial growth or utensil corrosion. These openings can be covered with mesh or filters to block contaminants.

In some embodiments, the body is equipped with external fasteners, such as magnets, clips, or clamps, allowing the device to be mounted on various surfaces. These fasteners may be rotatable or adjustable to accommodate different orientations and spaces.

The invention includes a method for storing and protecting utensils. A utensil is placed between the two halves, secured by the fasteners, and the halves are brought together and locked to create a protective seal. The device may then be mounted to a surface using the external fastener

Accordingly, the utensil protection device of the present invention is particularly advantageous as it provides a device that allows a user to maintain the cleanliness of their cooking utensils. More specifically, the device protects cooking utensils from contaminants. The device does so by enclosing a portion or the entirety of the utensil. In this manner, the utensil protection device provides a solution to protecting utensils while cooking outdoors.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a utensil protection device of the present invention while open in accordance with the disclosed architecture;

FIG. 2 illustrates a perspective view of one potential embodiment of a utensil protection device of the present invention while closed with utensils inside in accordance with the disclosed architecture;

FIG. 3 illustrates a perspective view of one potential embodiment of a utensil protection device of the present invention while open with utensils inside in accordance with the disclosed architecture; and

FIG. 4 illustrates a flowchart of a method of using one potential embodiment of a utensil protection device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that allows a user to maintain the cleanliness of their cooking utensils. There also exists a long-felt need in the art for a utensil protection device. More specifically, there exists a long-felt need in the art for a utensil protection device that protects cooking utensils from contaminants. Further, there exists a long-felt need in the art for a utensil protection device that protects cooking utensils from contaminants by enclosing a portion or the entirety of the utensil.

The present invention, in one exemplary embodiment, is comprised of a utensil protection device. The device comprises a body with a first and second half connected by at least one hinge. The halves can take various geometric shapes and are made from durable, food-grade materials such as metal or silicone, which resist heat and UV radiation. The halves are secured together using a locking mechanism that may include latches, clasps, magnetic seals, or screw-type closures. Seals or gaskets may be added to improve airtight and watertight properties, ensuring utensils are protected from contaminants.

Each half contains interior surfaces with fasteners designed to secure the utensil head or the entire utensil inside the device. When only the utensil head is stored, openings in each half allow the handle to protrude, with sealing components providing protection. The interior surfaces may be lined with soft materials, and the fasteners may include adjustable grooves, channels, elastic bands, or clips to securely hold utensils. Cushioning elements may be used to prevent damage.

The body may also include ventilation openings to promote airflow, preventing moisture buildup and reducing the risk of bacterial growth or utensil corrosion. These openings can be covered with mesh or filters to block contaminants.

In some versions, the body features external fasteners, such as magnets, clips, or clamps, allowing the device to be mounted on various surfaces. These fasteners may be rotatable or adjustable for flexible positioning.

The invention includes a method for storing and protecting utensils, where a utensil is placed between the halves, secured by the fasteners, and the halves are locked together to form a protective seal. The device can then be mounted on a surface using the external fastener.

Thus, the utensil protection device offers a solution for keeping utensils clean and safe from contaminants, particularly useful for outdoor cooking environments.

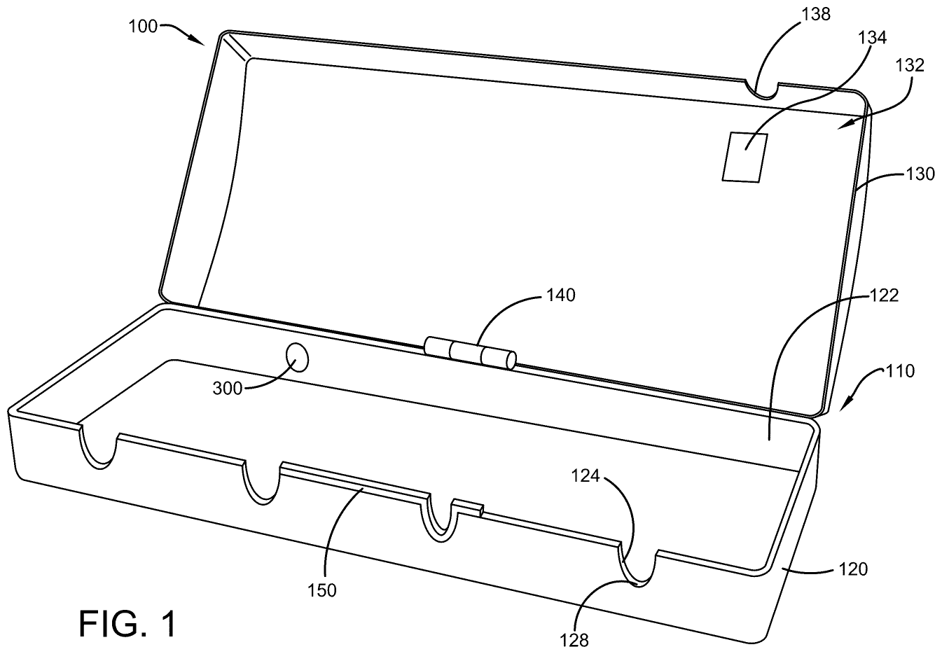

Referring initially to the drawings, FIG. 1 illustrates a perspective view of one potential embodiment of a utensil protection device 100 of the present invention while open in accordance with the disclosed architecture. The device 100 is comprised of a body 110. The body 110 is comprised of a first half 120 and a second half 130, which are preferably connected by at least one hinge 140. The halves 120, 130 may take any geometrical shape, such as rectangular, circular, or oval, depending on the intended design. The material used for the halves 120, 130 is preferably a durable, food-grade substance such as metal or silicone. This material is resistant to both heat and UV radiation, ensuring that the device 100 does not degrade or warp when exposed to sunlight or proximity to heat sources, such as grills.

The two halves 120, 130 can be further secured together via at least one locking mechanism 142, which may include but is not limited to latches, clasps, magnetic seals, or screw-type closures. The locking mechanism 142 ensures that when utensils 10 are stored inside the device 100, the halves 120,130 form a tight, protective seal that prevents the intrusion of dust, insects, and other contaminants. Additional seals or gaskets 150 may be incorporated along the edges of the halves 120, 130 to enhance the airtight and watertight properties of the device 100.

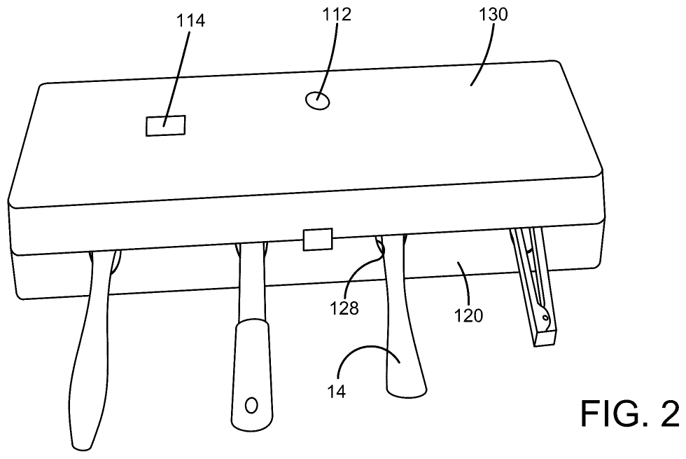

More specifically, each half 120, 130 is comprised of an interior surface 122, 132. The interior surfaces 122, 132 are designed to accommodate at least one fastener 124, 134. The fasteners 124, 134 are configured to secure the head 12 of a utensil 10, or in one embodiment, the entire utensil 10, within the device 100. In this configuration, the utensil 10 remains sanitary and is protected from debris, insects, or other contaminants. In an embodiment where only the head 12 of the utensil 10 is stored, each half 120, 130 is further comprised of at least one opening 128, 138 that allows the handle 14 of the utensil 10 to protrude from the body 110 while the device 100 is closed, as seen in FIG. 2. These openings 128, 138 may include sealing components 150 such as flexible gaskets or silicone flaps to maintain a protective barrier around the handle 14, ensuring that contaminants do not enter the body 110 through the openings.

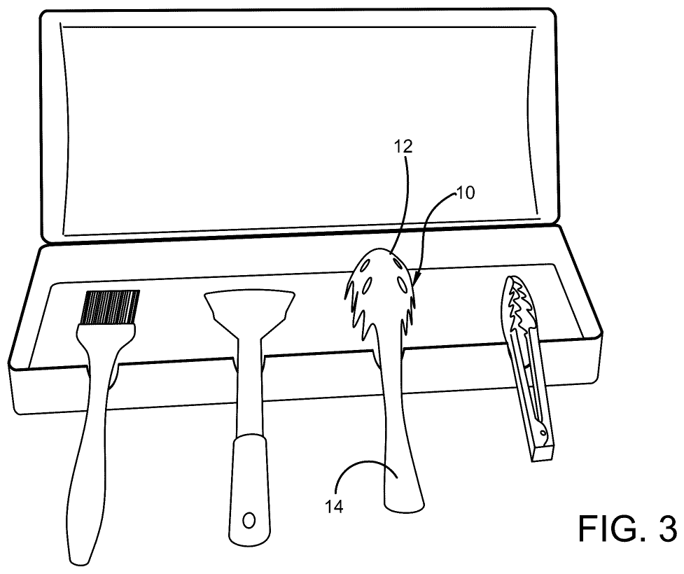

The interior surfaces 122, 132 are preferably lined with a soft, flexible, and dishwasher safe material such as but not limited to silicone to prevent scratches or damage to the utensils during storage. The fasteners 124, 134 may comprise grooves, channels, or slots into which the utensils 10 can be slid and securely held in place, as seen in FIG. 3. The grooves may be adjustable, allowing users to customize the interior configuration to fit utensils of different sizes or shapes. In addition to grooves, the fasteners 124, 134 may include or be alternatively comprised of elastic bands, clips, or other securing mechanisms designed to hold the utensil 10 tightly against the interior surface 122, 132. These fasteners 124, 134 could also be adjustable in tension, providing flexibility in how securely the utensil 10 is retained within the body 110. In another embodiment, the fasteners 124, 134 may be equipped with cushioning elements, such as foam inserts or rubber pads, to further protect delicate utensils from impact or abrasion. In one embodiment, the interior surfaces 122,132 are comprised of at least one UV 300 light that kills bacteria/germs on utensils 10 positioned within the device 100 during use.

In one embodiment, the body 110 is comprised of at least one ventilation opening 112. The opening 112 can take on various shapes such as circular perforations, slits, or a mesh configuration and is strategically placed to promote airflow inside the device 100. The airflow reduces the likelihood of moisture build-up, which could lead to bacterial growth or corrosion of the utensils 10. The size and positioning of the opening 112 may be optimized to balance ventilation and protection, ensuring that while moisture escapes, contaminants such as dust and insects are kept out. In another embodiment, the opening 112 may be covered with a fine mesh or filter to block the ingress of small particles.

In an additional embodiment, the body 110 is comprised of at least one external fastener 114 designed to allow the device 100 to be mounted or attached to a surface. The fastener 114 may take various forms, including but not limited to a magnet for attachment to metal surfaces, a clip for securing onto the edge of a grill or countertop, or a clamp for more permanent attachment to a storage area. The fastener 114 may also include suction cups or adhesive pads to allow temporary attachment to non-metallic surfaces, such as glass or plastic. Furthermore, in some embodiments, the fastener 114 may be rotatable or adjustable, allowing the device 100 to be oriented in different positions based on the user's preferences or the available space.

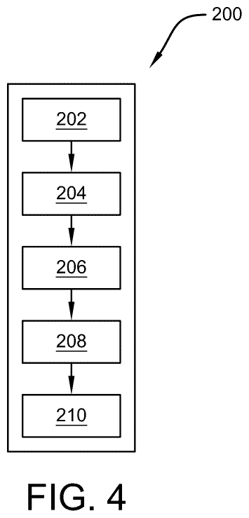

The present invention is also comprised of a method 200 for storing and protecting utensils using the device 100, as seen in FIG. 4. First, a device 100 is provided, comprised of a body 110 with a first half 120 and a second half 130 connected by at least one hinge 140, at least one locking mechanism 142, and fasteners 124, 134 on the interior surfaces 122, 132 of each half 120,130 [Step 202]. Next, the user places a utensil 10 between the first half 120 and second half 130, ensuring the head 12, or in one embodiment, the entire utensil 10, is secured by, within, or to the fasteners 124, 134 [Step 204]. If only the head 12 is stored, the user then positions the handle 14 through openings 128, 138 of each half 120,130 [Step 206]. Then, the first half 120 and second half 130 are brought together and secured via the locking mechanism 142 to create a tight seal, protecting the utensil 10 from dust, bugs, and other contaminants [Step 208]. The device 100 can then be mounted to a surface by attaching the fastener 114 to a desired location, such as a grill or countertop [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “utensil protection device” and “device” are interchangeable and refer to the utensil protection device 100 of the present invention.

Notwithstanding the forgoing, the utensil protection device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the utensil protection device 100 as shown in the FIGS. are for illustrative purposes only, and that many other sizes and shapes of the utensil protection device 100 are well within the scope of the present disclosure. Although the dimensions of the utensil protection device 100 are important design parameters for user convenience, the utensil protection device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A utensil protection device comprising:
a body comprising a first half and a second half, the first and second half connected by a hinge;
a locking mechanism configured to secure the first and second half together;
a first fastener located on a first interior surface of the first half and a second fastener located on a second interior surface of the second half, the first fastener and the second fastener configured to secure a utensil within the body; and
a first opening in the first half and a second opening in the second half to allow a handle of the utensil to protrude from the body while maintaining a protective barrier.

2. The utensil protection device of claim 1, wherein the first half is comprised of a food-grade silicone.

3. The utensil protection device of claim 1, wherein the second half is comprised of a food-grade silicone.

4. The utensil protection device of claim 1, wherein the first fastener is comprised of a groove, a channel, or a slot.

5. The utensil protection device of claim 1, wherein the second fastener is comprised of a groove, a channel, or a slot.

6. A utensil protection device comprising:
a body comprising a first half and a second half, the first and second half connected by a hinge;
a first gasket;
a locking mechanism configured to secure the first and second half together;
a first fastener located on a first interior surface of the first half and a second fastener located on a second interior surface of the second half, the first fastener and the second fastener configured to secure a utensil within the body; and
a first opening in the first half and a second opening in the second half to allow a handle of the utensil to protrude from the body while maintaining a protective barrier.

7. The utensil protection device of claim 6, wherein the first gasket is positioned on the first half.

8. The utensil protection device of claim 6 further comprised of a second gasket.

9. The utensil protection device of claim 8, wherein the second gasket is positioned on the second half.

10. The utensil protection device of claim 6, wherein the first half is comprised of a heat-resistant material.

11. The utensil protection device of claim 6, wherein the second half is comprised of a heat-resistant material.

12. The utensil protection device of claim 6, wherein the first half is comprised of a rubber or a silicone first interior surface.

13. The utensil protection device of claim 6, wherein the second half is comprised of a rubber or a silicone second interior surface.

14. The utensil protection device of claim 6, wherein the first half is comprised of a first ventilation hole.

15. The utensil protection device of claim 6, wherein the second half is comprised of a second ventilation hole.

16. A method of using a utensil protection device, the method comprising the following steps:
providing a utensil protection device comprised of a body comprised of a locking mechanism, a first half comprised of a first interior space comprised of a first fastener and a second half comprised of a second interior space comprised of a second fastener, the first half and the second half connected by a hinge;
placing a utensil between the first half and the second half, wherein the first fastener and the second fastener secure a portion of the utensil; and
closing the first half and the second half together and securing the first half to the second half with the locking mechanism to form a sealed enclosure around the utensil.

17. The method of using a utensil protection device of claim 16, wherein the first half is comprised of a first opening.

18. The method of using a utensil protection device of claim 17, wherein the second half is comprised of a second opening.

19. The method of using a utensil protection device of claim 17, wherein the first half is comprised of a first gasket.

20. The method of using a utensil protection device of claim 17, wherein the second half is comprised of a second gasket.
